(19) United States
(12) Patent Application Publication
(10) Pub. No.: US 2017/0284707 A1
(43) Pub. Date: Oct. 5, 2017

(54) ABSORPTION CHILLER

(71) Applicant: Mahle International GmbH, Stuttgart (DE)

(72) Inventors: Martin Brenner, Kieselbronn (DE); Georg Feldhaus, Stuttgart (DE); Marco Lorenz, Stuttgart (DE); Mario Wallisch, Aichtal (DE)

(21) Appl. No.: 15/471,888

(22) Filed: Mar. 28, 2017

(30) Foreign Application Priority Data
Mar. 29, 2016 (DE) 10 2016 205 120.2

(51) Int. Cl. F25B 15/16; F02G 5/02

(52) U.S. Cl. CPC F25B 15/16; F02G 5/02; F25B 2315/002; F25B 2500/01

(57) ABSTRACT

An absorption chiller may include an absorbent circuit in which a liquid absorbent circulates and a working medium circuit in which a liquid working medium circulates. The absorbent circuit may include an absorber and a desorber. The working medium circuit may include an evaporator and a condenser. The absorption chiller may also include a low pressure membrane arrangement and a high pressure membrane arrangement each being permeable to a working medium vapour, impermeable to the liquid working medium and the liquid absorbent, and arranged between the evaporator and the absorber such that it is in contact with the working medium and the absorbent. At least one of the low pressure membrane arrangement and the high pressure membrane arrangement may include a working medium membrane and an absorbent membrane.

### CROSS-REFERENCE TO RELATED APPLICATIONS

This application claims priority to German Patent Application No. DE 10 2016 205 120.2, filed on Mar. 29, 2016, the contents of which are hereby incorporated by reference in its entirety.

### TECHNICAL FIELD

The present invention relates to an absorption chiller, which is particularly suitable for exhaust heat recovery in an internal combustion engine, preferably in a motor vehicle. The invention furthermore concerns a method for the operation of such an absorption chiller.

### BACKGROUND

From DE 10 2010 049 916 A1 it is of known art to use waste heat from an exhaust flow of an internal combustion engine to provide an absorption chiller, which has a cooling circuit. The cooling circuit contains a condenser, an evaporator, an absorber and a desorber. The heat transfer coupling with the exhaust flow of the internal combustion engine takes place via the desorber. In the absorption chiller of known art, absorbers, desorbers, evaporators and condensers are separate components, which require a comparatively large amount of installation space.

### SUMMARY

The present invention is concerned with the problem of specifying an improved or at least another form of embodiment for an absorption chiller that is characterised by a particularly compact design.

In accordance with the invention this problem is solved by means of the subject matter of the independent claims. Advantageous forms of embodiment are the subject matter of the dependent claims.

The inventive absorption chiller comprises an absorbent circuit in which an absorbent circulates, and which has an absorber as well as a desorber, and a working medium circuit in which a working medium circulates, and which has an evaporator and a condenser. Thus, two separate circuits are provided, on the one hand to conduct the absorbent, and on the other hand to conduct the working medium. These two separate circuits are coupled together with the aid of two membrane arrangements, namely via a low pressure membrane arrangement, which is referred to below as an LP membrane arrangement, and via a high pressure membrane arrangement, which hereinafter is also referred to as an HP membrane arrangement. The LP membrane arrangement is permeable to working medium vapour, while being impermeable to a liquid working medium and a liquid absorbent. Thus, working medium vapour can pass from the working medium circuit into the absorbent circuit via the LP membrane arrangement. Furthermore, the LP membrane arrangement is arranged between the evaporator and the absorber such that, on the one hand, it is exposed directly to the working medium, and on the other hand, to the absorbent, that is to say, it is in contact with the latter during operation of the absorption chiller. Thus, a working medium vapour can pass from the working medium into the absorbent via the LP membrane arrangement. The HP membrane arrangement is similarly permeable to working medium vapour, while being impermeable to a liquid working medium and a liquid absorbent. In principle, the LP membrane arrangement and the HP membrane arrangement can be constructed identically. The HP membrane arrangement is arranged between the desorber and the condenser, such that, on the one hand, it is exposed directly to the working medium and, on the other hand, to the absorbent, that is to say, it is in contact with the latter during operation of the absorption chiller. Thus, working medium vapour can pass from the absorbent circuit directly via the HP membrane arrangement into the working medium circuit. As a result of these measures, the absorption chiller here proposed is extremely compact on the one hand in the region of the absorber and the evaporator, and on the other hand, in the region of the desorber and the condenser, so that the absorption chiller requires little installation space.

Particularly advantageous is now a form of embodiment in which at least one of these membrane arrangements has a working medium membrane and also an absorbent membrane. The working medium membrane is directly exposed to the working medium and is thus in contact with the latter during operation of the absorption chiller. The working medium membrane is permeable to working medium vapour, while being impermeable to a liquid working medium. The absorbent membrane is directly exposed to the absorbent and is in contact with the absorbent during operation of the absorption chiller. The absorbent membrane is permeable to working medium vapour, while being impermeable to a liquid absorbent. By means of these two separate membranes within the membrane arrangement in question, the absorber and evaporator can, on the one hand, be better thermally separated from one another when the membrane arrangement is the LP membrane arrangement, or the desorber and condenser can, on the other hand, be better thermally separated from one another when the membrane arrangement is the HP membrane arrangement, as a result of which parasitic heat flows, which reduce the efficiency of the absorption chiller, can be reduced. Accordingly, the membrane arrangement in question, with at least two membranes, can improve the efficiency of the absorption chiller. The membrane arrangement in question preferably possesses precisely two separate membranes, namely the working medium membrane and the absorbent membrane. In this case, the membrane arrangement in question is configured as a double membrane. Here preference is given to a form of embodiment in which both the LP membrane arrangement and the HP membrane arrangement are each fitted with such a working medium membrane and such an absorbent membrane. The working medium membrane and the absorbent membrane can in principle consist of the identical membrane material. Expediently, however, they can consist of different membrane materials, which are adapted, for example, to the pressure range in question, namely LP or HP.

According to an advantageous development, an interspace can be formed in the membrane arrangement in question between the working medium membrane and the absorbent membrane. With the aid of such an interspace, undesirable heat flows can be further reduced.

Particularly advantageous is a development in which a reduced pressure prevails in the interspace, which lies below the low pressure, and which in particular lies below an atmospheric ambient pressure, which is usually about 1 bar. On the one hand the thermal insulation effect is improved by a reduced pressure in the interspace. On the other hand, the partial pressure difference on the respective membrane for the working medium vapour is thereby increased, which increases the permeability of the respective membrane to the working medium vapour. In addition, this increases the partial pressure fraction of the working medium vapour in the interspace, which is also advantageous for the efficiency of the absorption chiller. In particular, the volumetric flow rate of the working medium vapour can be increased.

The use of two separate membranes, with or without an interspace, also makes it possible to operate both the absorbent circuit and the working medium circuit at an elevated pressure, that is to say, at a pressure that is above the ambient pressure. In other words, both the HP in the region of the condenser and the absorber, and the LP in the region of the desorber and the condenser, lie above the ambient pressure. By this means the risk of foreign gases entering the working medium or the absorbent is reduced.

A further advantageous development is one in which a spacer layer is provided within the respective membrane arrangement; this is arranged between the respective working medium membrane and the respective absorbent membrane in order to form the said interspace. The spacer layer is thereby permeable to working medium vapour. It is formed, for example, in terms of a lattice structure or fabric structure, and is thus usually also permeable to the liquid working medium and the liquid absorbent. Both the working medium membrane and the absorbent membrane can sit closely against the spacer layer. The spacer layer can in particular provide a stiffening or stabilisation of the respective membrane arrangement, since the membranes used for this purpose are usually relatively flexible in bending.

In accordance with an advantageous form of embodiment, the absorption chiller can be fitted with an evaporator-absorber unit. As a result, a particularly compact module is provided for the evaporator and the absorber. Expediently, an absorbent path for conducting the absorbent, and a working medium path for conducting the working medium through the LP membrane arrangement, are separated from one another in the evaporator-absorber unit.

A further advantageous development is one in which a low pressure heat removal (LP heat removal) system for removing heat from the absorber has a low pressure coolant path (LP coolant path) for conducting a coolant which is coupled in the evaporator-absorber unit with the absorbent path, such that heat is transferred while the media remain separated. In this manner the LP heat removal system is integrated into the evaporator-absorber unit with respect to its cooling function.

In another further development a low pressure heat supply system (LP heat supply system) for supplying heat to the evaporator can additionally or alternatively have a low pressure heating medium path (LP heating medium path) for conducting a heating medium, which is coupled in the evaporator-absorber unit with the working medium path, such that heat is transferred while the media remain separated. In this manner the LP heat supply system can be integrated into the evaporator-absorber unit with respect to its heating function.

Such an evaporator-absorber unit is particularly advantageously provided if the LP membrane arrangement is fitted with such a working medium membrane and such an absorbent membrane.

In another form of embodiment, the absorption chiller can be fitted with a condenser-desorber unit, whereby condenser and desorber form a compact unit. Expediently, an absorbent path for conducting the absorbent through the HP membrane arrangement can be separated from a working medium path for conducting the working medium.

In accordance with an advantageous further development a high pressure heat removal (HP heat removal) system for removing heat from the condenser can be provided, which has a high pressure coolant path (HP coolant path) for conducting a coolant, which is coupled in the condenser-desorber unit with the working medium path, such that heat is transferred while the media remain separated. In this manner the cooling function of the HP heat removal system can be integrated into the condenser-desorber unit.

Additionally or alternatively a high pressure heat supply system (HP heat supply system) for supplying heat from the desorber can be provided, which has a high pressure heating medium path (HP heating medium path) for conducting a heating medium, which is coupled in the condenser-desorber unit with the absorbent path such that heat is transferred while the media remain separated. In this manner the heating function of the HP heat supply system can be integrated into the condenser-desorber unit.

Such a condenser-desorber unit is particularly expedient if the HP membrane arrangement is fitted with such a working medium membrane and such an absorbent membrane.

Within the respective unit, the heat-transferring and media-separated coupling can take place by means of a heat exchanger structure, which is impermeable to the respective media. For example, this can take the form of an unstructured or a structured plate or sheet, for example of a metal. For example, a steel plate or steel sheet, preferably a stainless steel plate or stainless steel sheet, can be used.

In another advantageous form of embodiment, a recuperator can be arranged in the absorbent circuit, which couples a feed line of the absorbent circuit leading from the absorber to the desorber with a return line of the absorbent circuit leading from the desorber to the absorber, such that heat is transferred while the media remain separated. The energy efficiency of the absorption chiller can thereby be significantly increased.

The individual membranes, which are used in the respective membrane arrangement, can be configured as hollow fibre membranes. However, preference is given to a form of embodiment in which the membranes are designed as flat membranes.

An inventive method for operating an absorption chiller of the type described above is characterised in that the high pressure (HP) lies above the low pressure (LP), and in that the high pressure and the low pressure in the absorbent circuit within the liquid absorbent and in the working medium circuit lie above an atmospheric ambient pressure, which as a general rule is about 1 bar. In contrast, a reduced pressure (RP), which preferably lies below the ambient pressure, is established in an interspace, which is located within the respective membrane arrangement between the working medium membrane and the absorbent membrane. In other words, the absorbent circuit and the working medium circuit are each operated at an elevated pressure in the liquid phase, while a reduced pressure is set within the respective membrane arrangement in the said interspace. By means of this mode of operation, on the one hand, the danger of the penetration of foreign gases from the environment into the working medium or into the absorbent is reduced, while on the other hand the volumetric flow rate of the working medium vapour can be increased. At the same time, a parasitic heat transfer within the membrane arrangement is reduced. Overall, the efficiency of the absorption chiller can thus be improved. In order to adjust the said reduced pressure, a preliminary evacuation can firstly be carried out in the respective interspace in the course of production of the respective membrane arrangement, e.g. in order to remove disruptive foreign gases. Subsequently, the respective reduced pressure then self adjusts during operation, namely as a result of the vapour pressure of the working medium vapour. In the case of a lithium bromide water solution, the said reduced pressure in the interspace of the LP membrane arrangement can be about 10 mbar, while in the interspace of the HP membrane arrangement it can be about 100 mbar.

In the present context, “LP” always stands for “low pressure”, while “HP” always stands for high pressure, whereby relatively the terms are to be understood to mean that the HP lies above the LP.

Further important features and advantages of the invention ensue from the dependent claims, from the figures and from the related description based upon the figures.

It is evident that the features cited above and those still to be explained below can be used not only in the combination as specified in each case, but also in other combinations, or individually, without moving outside the context of the present invention.

Preferred examples of embodiment of the invention are represented in the figures and are explained in more detail in the following description, wherein the same reference symbols refer to the same, or similar, or functionally similar, components.

### BRIEF DESCRIPTION OF THE DRAWINGS

Here, in schematic form:

FIG. 1 shows a pressure-temperature diagram illustrating an absorption chiller,

FIG. 2 shows a greatly simplified cross-sectional view in the region of a membrane arrangement of the absorption chiller,

FIG. 3 shows a greatly simplified cross-sectional view of a condenser-desorber unit of the absorption chiller,

FIG. 4 shows a greatly simplified cross-sectional view of an evaporator-absorber unit of the absorption chiller,

FIG. 5 shows a cross-sectional view as in FIG. 3 with additional details in the region of the membrane arrangement.

### DETAILED DESCRIPTION

In accordance with FIG. 1, the pressure P is located on the ordinate in the diagram as shown, and the temperature T is located on the abscissa. By this means the position of the most important components of an absorption chiller 1 with respect to temperature and pressure can be illustrated on this P-T diagram. The absorption chiller 1, which can, for example, be deployed in an internal combustion engine for purposes of exhaust heat recovery, comprises an absorbent circuit 2, in which an absorbent circulates, and which has an absorber 3 and a desorber 4. A feed line 5 of the absorbent circuit 2 conducts the absorbent from the absorber 3 to the desorber 4. In the feed line 5 is arranged an absorbent pump 6. A return line 7 of the absorbent circuit 2 leads back from the desorber 4 to the absorber 3 and can contain a restrictor 8. The absorption chiller 1 also has a working medium circuit 9, in which a working medium circulates, and which has an evaporator 10 and a condenser 11. A feed line 12 of the working medium circuit 9 conducts the working medium from the evaporator 10 to the condenser 11. In the diagram of FIG. 1, this feed line 12 of the working medium circuit 9 runs within the feed line 5 of the absorbent circuit 2; this is due to the fact that the evaporated working medium is absorbed in the absorbent and is conducted therein from the absorber 3 to the desorber 4, and only there is once again separated from the absorbent. A separate pump for driving the working medium in the working medium circuit 9 can then be dispensed with in this theoretical representation, that is to say, in this representation of the principles involved. In theory, therefore, the feed line 5 of the absorbent circuit 2 and the feed line 12 of the working medium circuit 9 are conducted along a common line. In practice, however, separate lines can be provided for the feed line 5 of the absorbent circuit 2 and the feed line 12 of the working medium circuit 9, wherein an absorbent enriched with working medium is conducted along the feed line 5 of the absorbent circuit 2, while the unevaporated remainder of the working medium is conducted along the feed line 12 of the working medium circuit 9. Expediently, a separate pump for driving the working medium can then be arranged in the feed line 12 of the working medium circuit 9. A return line 13 of the working medium circuit 9 leads the working medium back from the condenser 11 to the evaporator 10, and can contain a restrictor 14.

Here, for improved energy efficiency, a recuperator 15 is arranged in the absorbent circuit 2, so as to couple the feed line 5 of the absorbent circuit 2 with the return line 7 of the absorbent circuit 2, with the transfer of heat. Here the recuperator 15 takes the form of a heat exchanger in which the heat transfer takes place between media that remain separated.

As can be seen in the diagram of FIG. 1, evaporator 10 and absorber 3 are located in the region of an evaporator pressure P_{EVAP}, that is to say, in a low pressure region LP. In contrast, the condenser 11 and desorber 4 are located in the region of a condensation pressure P_{KOND}, that is to say in a high pressure region HP.

According to FIG. 1, heat Q_{EVAP} can be supplied to the evaporator 10 with the aid of an LP heat supply system 16, which is indicated by an arrow. With the aid of an LP heat removal system 17, the corresponding heat Q_{ABS} can be removed from the absorber 3. With the aid of an HP heat supply system 18, the heat Q_{DES} can be supplied to the desorber 3. With the aid of an HP heat removal system 19, heat Q_{KOND} can conversely be removed from the evaporator 11. The LP heat supply system 16 operates at an evaporation temperature T_{EVAP}. The LP heat removal system 17 operates at an absorption temperature T_{ABS}. The HP heat supply system 18 operates at a desorption temperature T_{DES}. The HP heat removal system 19 operates at a condensation temperature T_{KOND}, which approximately corresponds to the absorption temperature T_{ABS}. The difference between the heat release temperature T_{KOND} and/or T_{ABS} on the one hand, and the chilling temperature or heat absorption temperature T_{EVAP}, on the other hand, is referred to as the temperature rise ΔT_{H}, so that: ΔT_{H}=T_{KOND}−T_{EVAP}.

The cycle of the absorption chiller 1 proceeds in the following manner. The working medium, preferably water, evaporates in the evaporator 10, with the absorption of the evaporative heat output Q_{EVAP}. The working medium vapour generated is supplied to the absorber 3, where it is absorbed by the absorbent with the release of the heat flux Q_{ABS}. This absorbent is a mixture of the working medium itself and one or a plurality of other substances: It can, for example, take the form of a lithium bromide-water solution (LiBr—H₂O-solution). In the absorbent, an increase in boiling point occurs compared with the pure working medium. The working medium vapour is therefore absorbed under the same pressure P_{EVAP} as in the evaporator 10, but at a higher temperature T_{ABS}, with the release of the heat flux Q_{ABS} in the absorber 3. The absorbent, now enriched by the working medium, leaves the absorber 3 with a concentration X_{DES}. With the pump 6, the absorbent is brought up to the higher pressure P_{KOND} and supplied to the desorber 4, which can also be referred to as an expeller. In comparison to the evaporative heat output, the pump power output is comparatively low, since for practical purposes the liquid that has to be pumped is incompressible.

In the desorber 4, the working medium is evaporated out of the absorbent once again by supplying the drive or desorption heat output Q_{DES} at the temperature T_{DES}. The resulting working medium vapour is liquefied at the pressure P_{KOND} as in the case of a compression cooling circuit in the condenser 11, with the release of the condensation heat flux Q_{KOND}. The liquid working medium can then be supplied back to the evaporator 10 via the restrictor 14, as a result of which the working medium circuit 9 is completed. The absorbent that flows out of the desorber 4, which now has a concentration X_{ABS} reduced in terms of the working medium, is expanded via the restrictor 8 and supplied to the absorber 3. There, the absorbent can once again absorb the working medium vapour. Thus the absorbent circuit 2 is also completed. The difference between the exiting and entering concentrations X_{ABS} and X_{DES} is referred to as the degassing width ΔX, so that: ΔX=X_{ABS}−X_{DES}.

The temperatures of the condenser 11 and the absorber 3 are approximately at the same level, so that the condensation heat output Q_{KOND} and the absorption heat output Q_{ABS}, as shown in FIG. 1, occur at the same temperature, namely T_{ABS} and T_{KOND}, respectively. However, if heat can be utilised at a plurality of temperature levels, different temperatures can also be selected for the condenser 11 and the absorber 3.

As can also be seen in FIG. 1, the absorbent that is rich in working medium, must be heated from the absorber temperature T_{ABS} to the desorber temperature T_{DES}. In contrast, the absorbent that is poor in working medium, must be cooled from the desorber temperature T_{DES} to the absorber temperature T_{ABS}. This drive heat output required for this purpose, to be applied in the desorber 4, or the heat output to be released in the absorber 3, can be significantly reduced by the recuperator 15, in which the absorbent that is rich in working medium, coming from the absorber 3, preferably in the counter-flow, is heated by cooling the absorbent that is poor in working medium exiting from the desorber 4.

The transfer of the evaporated working medium into the absorbent is indicated in FIG. 1 by an arrow 20, which leads from the evaporator 10 to the absorber 3. In the absorption chiller 1 as presented here, this is achieved with the aid of an LP membrane arrangement 21, which is arranged between the evaporator 10 and the absorber 3. Furthermore in FIG. 1, the return of the working medium vapour from the desorber 4 to the condenser 11 is indicated by an arrow 22, which leads from the desorber 4 to the condenser 11. In the absorption chiller 1 as presented here, this is implemented with the aid of an HP membrane arrangement 23, which is arranged between the desorber 4 and the condenser 11.

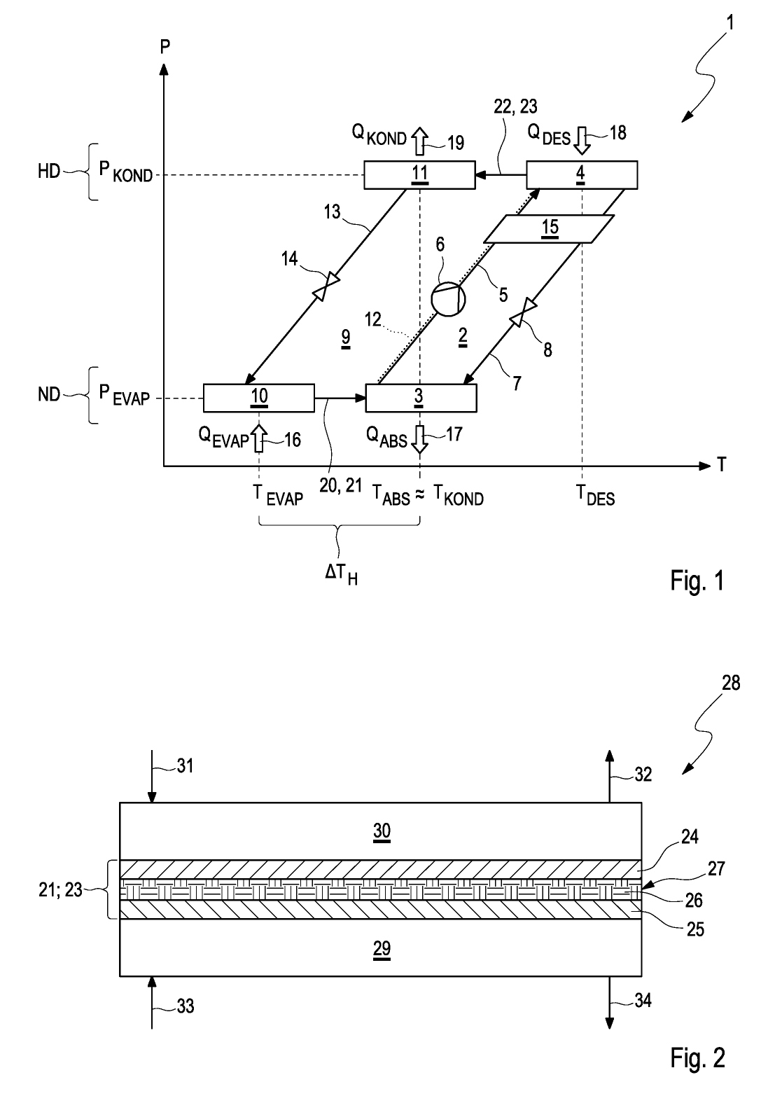

In accordance with FIG. 2 the respective membrane arrangement 21, 23 is permeable to working medium vapour, while being impermeable to a liquid working medium and a liquid absorbent. Furthermore, the respective membrane arrangement 21, 23 between the evaporator 10 and the absorber 3, or between the desorber 4 and the condenser 11, is arranged such that the respective membrane arrangement 21, 23 is on the one hand in direct contact with the working medium and, on the other hand, is in direct contact with the absorbent. The formulation “respective membrane arrangement” used in the present context refers to the LP membrane arrangement 21 and/or to the HP membrane arrangement 23.

In accordance with FIGS. 2 to 5, at least one of these membrane arrangements 21, 23, preferably both membrane arrangements 21, 23, has in each case a working medium membrane 24, together with an absorbent membrane 25 that is separate in this respect. The working medium membrane 24 is in direct contact with the working medium, and is permeable to working medium vapour, while being impermeable to a liquid working medium. The absorbent membrane 25 is in direct contact with the absorbent, and is permeable to working medium vapour, while being impermeable to a liquid absorbent.

In the forms of embodiment shown here, an interspace 26 is arranged or formed in the respective membrane arrangement 21, 23 between the working medium membrane 24 and the absorbent membrane 25. The interspace 26 is preferably implemented by means of a spacer layer 27, which is arranged between the working medium membrane 24 and the absorbent membrane 25, and which is permeable to the working medium vapour. Both the working medium membrane 24 and the absorbent membrane 25 sit closely against the spacer layer 27. In particular, the spacer layer 27 can take the form of a fabric structure or a lattice structure, and/or a component made of a plastic or metal.

In FIG. 2 is shown a base unit 28, which has such a membrane arrangement 21, 23 together with an absorbent path 29 for conducting the absorbent, and a working medium path 30 for guiding the working medium. Here the absorbent path 29 and the working medium path 30 are separated from one another within the base unit 28 by the membrane arrangement 21, 23. The arrangement is effected within the base unit 28 such that the membrane arrangement 21, 23 is both in direct contact with the absorbent conducted along the absorbent path 29, and also in direct contact with the working medium conducted along the working medium path 30. Specifically, the absorbent membrane 25 is in contact with the absorbent conducted along the absorbent path 29, while the working medium membrane 24 is in direct contact with the working medium conducted along the working medium path 30. In FIG. 2, a working medium inlet 31, a working medium outlet 32, an absorbent inlet 33, and an absorbent outlet 34, are indicated by arrows. The absorbent path 29 and the working medium path 30 can take the form of ducts or conduits which, depending upon the geometrical extent of the respective membrane arrangement 21, 23, are preferably configured so as to be planar.

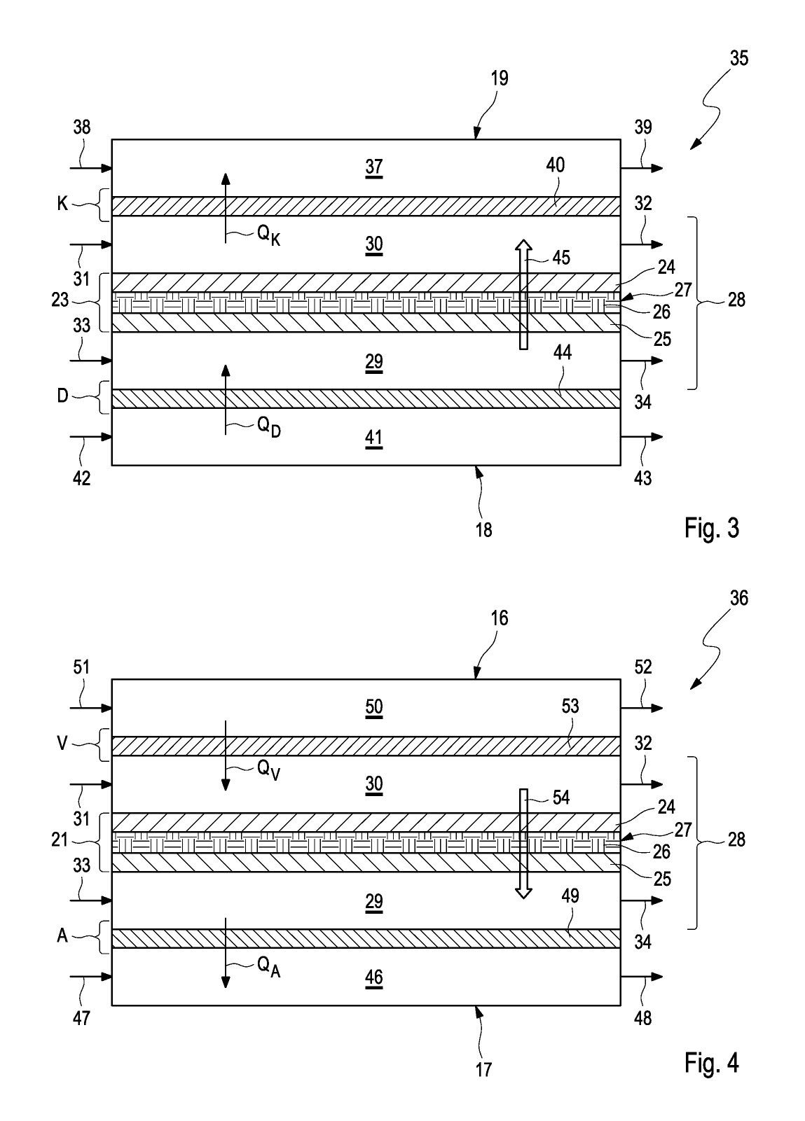

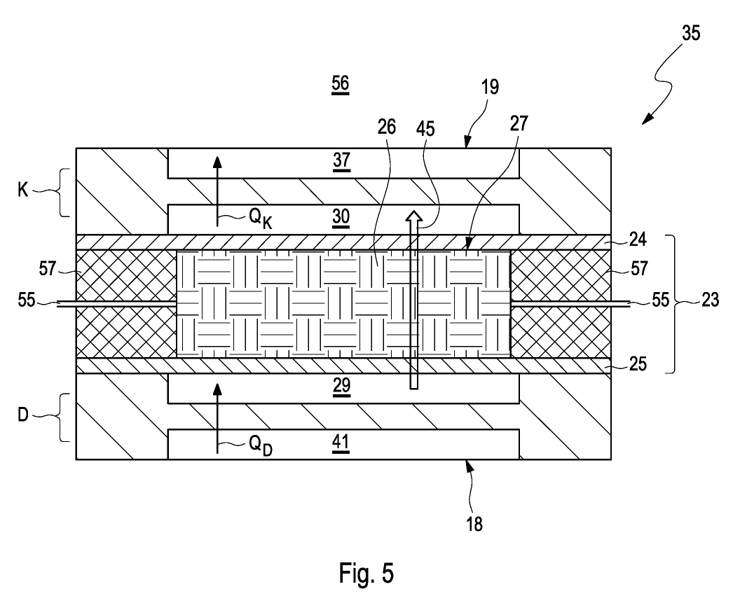

The base unit 28 shown in FIG. 2 is also located in a condenser-desorber unit 35 shown in FIGS. 3 and 5, and also in an evaporator-absorber unit 36 shown in FIG. 4.

In accordance with FIGS. 3 and 5, the base unit 28 thereby contains the HP membrane arrangement 23. In addition to the base unit 28, the condenser-desorber unit 35 is fitted with an HD coolant path 37 of the HD heat removal system 19, wherein a coolant inlet 38 and a coolant outlet 39 are indicated by arrows. The HP coolant path 37 conducts a coolant and is thereby coupled within the condenser-desorber unit 35 with the working medium path 30, such that heat is transferred while the media remain separated. This is achieved here by means of a heat exchanger structure 40. Further, the condenser-desorber unit 35 is fitted with an HP heating medium path 41 of the HP heat supply system 18, which serves to conduct a heating medium. A corresponding heating medium inlet 42 and a heating medium outlet 43 are indicated by arrows. Within the condenser-desorber unit 35 the HP heating medium path 41 is coupled with the absorbent path 29, such that heat is transferred while the media remain separated. This is similarly achieved here by means of a heat exchanger structure 44. During the operation of the absorption chiller 1, desorption heat Q_{D} through the heat exchanger structure 44 is thus supplied via the heat exchanger structure 44 to the absorbent enriched with working medium in the absorbent path 29, wherein working medium vapour is generated, which in accordance with an arrow 45 passes through the HP membrane arrangement 23, and thus reaches the working medium path 30. Condensation of the working medium vapour then takes place in the working medium. The condensation heat Q_{K} thereby resulting is supplied via the heat exchanger structure 40 to the coolant in the HP coolant path 37. In the capacitor-desorber unit 35, the desorber region is denoted by D and the condenser region by K.

In accordance with FIG. 4, the evaporator-absorber unit 36 also contains such a base unit 28. In addition, an LP coolant path 46 of the low pressure heat removal system is provided, which conducts a coolant. A corresponding coolant inlet 47 and coolant outlet 48 are indicated by arrows. Within the evaporator-absorber unit 36 the LP coolant path 46 is coupled with the absorbent path 29, such that heat is transferred while the media remain separated. This is once again implemented by means of a heat exchanger structure 49. Furthermore, an LP heating medium path 50 is provided, which is incorporated into the LP heat supply system 16, or forms a part thereof. The LP heating medium path 50 serves to conduct a heating medium. A corresponding heating medium inlet 51 and heating medium outlet 52 are indicated by arrows. The low pressure heating medium path 50 is coupled with the working medium path 30, such that heat is transferred while the media remain separated, for example via an appropriate heat exchanger structure 53. In the evaporator-absorber unit 36 an evaporator region is denoted by V and an absorber region by A.

During the operation of the absorption chiller 1 heat Q_{V} is transferred via the LP heating medium path 50 through the heat exchanger structure 53 from the heating medium into the working medium conducted along the working medium path 30. As a result of the heating of the working medium evaporation of the latter takes place. The working medium vapour can then in accordance with an arrow 54 pass from the working medium path 30, through the LP membrane arrangement 21, into the absorbent conducted along the absorbent path 29. The working medium vapour is absorbed in this process. The absorption heat Q_{A} that is thereby released is transferred through the heat exchanger structure 49 into the cooling medium conducted along the LP cooling medium path 46 and removed.

Here the membranes 24, 25 that are employed are preferably configured as planar membranes. The heat exchanger structures 40, 44, 49, 53 can expediently be configured as metallic plates. Here they can, for example, take the form of stainless steel plates. The heat exchanger structures 40, 44, 49, 53 can be unstructured, that is to say, in particular they can be smooth and/or even, or they can be structured, that is to say, they can, in particular, be fitted with a corrugated structure and/or with projections.

In accordance with FIG. 5 at least one evacuation line 55 can be connected to the interspace 26 in the region of the HP membrane arrangement 23, so as to be able to suck any disruptive foreign gases out of the said interspace 26. This suction or evacuation of foreign gases is executed at least once, namely after filling the working medium circuit 9 with liquid working medium, and after filling the absorbent circuit 2 with liquid absorbent. Subsequently, a suction or evacuation of foreign gas can be executed regularly or dependent on need during the operation of the absorption chiller 1, e.g., depending upon the quality of the sealing of the circuits 2, 9 and the demands of the absorption chiller 1. During the operation of the absorption chiller 1 a reduced pressure occurs in the respective interspace 26, by virtue of the passage of the working medium vapour through the membranes 24, 25. This reduced pressure preferably lies below an ambient pressure that prevails in an environment 56 of the absorption chiller 1. For example, an ambient pressure of approximately 1 bar prevails in the environment 56. The reduced pressure can, for example, lie at 0.1 bar in the interspace 26 of the HP membrane arrangement, and can. for example, lie at approximately 0.01 bar in the interspace 26 of the LP membrane arrangement, e.g. if water is used as the working medium and a lithium bromide-water solution is used as the absorbent. In contrast, there is an elevated pressure in the working fluid path 30 within the liquid working medium, and in the absorbent path 29 within the liquid absorbent, that is to say, in each case this is a pressure that lies above the ambient pressure. Here it is clear that the low pressure is less than the high pressure. The respective evacuation line 55 is thereby expediently passed through a seal 57 which, on the one hand seals the working medium membrane 24 with respect to the absorbent membrane 25, and on the other hand seals the interspace 26 from the environment 56.

1. An absorption chiller, comprising:
an absorbent circuit in which a liquid absorbent circulates, the absorbent circuit including an absorber and a desorber;
a working medium circuit in which a liquid working medium circulates, the working medium circuit including an evaporator and a condenser;
a low pressure membrane arrangement permeable to a working medium vapour, impermeable to the liquid working medium and the liquid absorbent, and arranged between the evaporator and the absorber such that the low pressure membrane arrangement is in contact with the working medium and the absorbent;
a high pressure membrane arrangement permeable to the working medium vapour, impermeable to the liquid working medium and the liquid absorbent, and arranged between the desorber and the condenser such that the high pressure membrane arrangement is in contact with the working medium and the absorbent; and
wherein at least one of the low pressure membrane arrangements and the high pressure membrane arrangement includes:
a working medium membrane in contact with the working medium, the working medium membrane being permeable to the working medium vapour, and impermeable to the liquid working medium; and
an absorbent membrane in contact with the absorbent, the absorbent membrane being permeable to the working medium vapour and impermeable to the liquid absorbent.

2. The absorption chiller in accordance with claim 1, wherein the at least one of the low pressure membrane arrangement and the high pressure membrane arrangement includes an interspace between the working medium membrane and the absorbent membrane.

3. The absorption chiller in accordance with claim 2, wherein the interspace is evacuated to a reduced pressure that lies below a pressure of the desorber that is above ambient pressure.

4. The absorption chiller in accordance with claim 2, wherein the interspace includes a spacer layer permeable to the working medium vapour, the spacer layer arranged such that the working medium membrane sits closely on one side and the absorbent membrane sits closely on the other side.

5. The absorption chiller in accordance with claim 1, wherein the low pressure membrane arrangement includes the working medium membrane and the absorbent membrane.

6. The absorption chiller in accordance with claim 1, further comprising an evaporator-absorber unit including an absorbent path for conducting the liquid absorbent and a working medium path for conducting the liquid working medium, wherein the absorbent path and the working medium path are separated from one another via the low pressure membrane arrangement.

7. The absorption chiller in accordance with claim 6, further comprising a low pressure heat removal system including a low pressure coolant path for conducting a coolant, the low pressure coolant path coupled to the absorbent path such that heat is transfer able and the liquid absorbent remains separated from the coolant.

8. The absorption chiller in accordance with claim 6 further comprising a low pressure heat supply system for supplying heat to the evaporator and that has a low pressure heating medium path for conducting a heating medium, the low pressure heating medium path coupled in the evaporator-absorber unit to the working medium path such that heat is transferable and the liquid working medium remains separated from the heating medium.

9. The absorption chiller in accordance with claim 1, wherein the high pressure membrane arrangement includes the working medium membrane and the absorbent membrane.

10. The absorption chiller in accordance with claim 1, further comprising a condenser-desorber unit including an absorbent path for conducting the liquid absorbent and a working medium path for conducting the liquid working medium, wherein the absorbent path and the working medium path are separated from one another via the high pressure membrane arrangement.

11. The absorption chiller in accordance with claim 10, further comprising a high pressure heat removal system including a high pressure coolant path for conducting a coolant, the high pressure coolant path coupled to the working medium such that heat is transfer able and the liquid working medium remains separated from the coolant.

12. The absorption chiller in accordance with claim 10 further comprising a high pressure heat supply system including a high pressure heating medium path for conducting a heating medium, the high pressure heating medium path coupled coupled to the absorbent path such that heat is transferable and the liquid absorbent remains separated from the heating medium.

13. The absorption chiller in accordance with claim 7, wherein the low pressure coolant path is coupled to the absorbent path via a metallic heat transfer structure.

14. The absorption chiller in accordance with claim 1, further comprising:
a recuperator arranged in the absorption circuit;
wherein the absorption circuit includes a feed line extending from the absorber to the desorber and a return line extending from the desorber to the absorber; and
wherein the recuperator couples the feed line with the return line such that heat is transferable while the media and media of the feed line remains separated from media of the return line.

15. A method, comprising:
providing an absorption chiller having:
an absorbent circuit in which a liquid absorbent circulates, the absorbent circuit including an absorber arranged in a region of a first pressure and a desorber arranged in a region of a second pressure, the first pressure being greater than an ambient pressure and less than the second pressure;
a working medium circuit in which a liquid working medium circulates, including an evaporator arranged in the region of the first pressure and a condenser arranged in the region of the second pressure;
a low pressure membrane arrangement permeable to a working medium vapour, impermeable to the liquid working medium and the liquid absorbent, and arranged between the evaporator and the absorber such that it is in contact with the working medium and the absorbent; and
a high pressure membrane arrangement permeable to the working medium vapour, impermeable to the liquid working medium and the liquid absorbent, and arranged between the desorber and the condenser such that it is in contact with the working medium and the absorbent;
wherein at least one of the low pressure membrane arrangement and the high pressure membrane arrangement includes:
a working medium membrane in contact with the working medium, the working medium membrane being permeable to the working medium vapour, and impermeable to the liquid working medium;
an absorbent membrane in contact with the absorbent, the absorbent membrane being permeable to the working medium vapour and impermeable to the liquid absorbent; and
an interspace arranged between the working medium membrane and the absorbent membrane; and
evacuating the interspace to a reduced pressure that lies below the ambient pressure.

16. The absorption chiller in accordance with claim 3, therein the interspace includes a spacer layer permeable to the working medium vapour, the spacer layer arranged such that the working medium membrane sits closely on one side and the absorbent membrane sits closely on the other side.

17. The absorption chiller in accordance with claim 2, wherein the low pressure membrane arrangement includes the working medium membrane and the absorbent membrane.

18. The absorption chiller in accordance with claim 2, wherein the high pressure membrane arrangement includes the medium membrane and the absorbent membrane.

19. The absorption chiller in accordance with claim 2, further comprising:
a recuperator arranged in the absorption circuit;
wherein the absorption circuit includes a feed line extending from the absorber to the desorber and a return line extending from the desorber to the absorber; and
wherein the recuperator couples the feed line with the return line such that heat is transferable and media of the feed line remains separated from media of the return line.

20. An absorption chiller, comprising:
an absorbent circuit in which a liquid absorbent circulates, the absorbent circuit including an absorber arranged in a region of a first pressure and a desorber arranged in a region of a second pressure, the first pressure being greater than an ambient pressure and less than the second pressure;
a recuperator arranged in the absorption circuit;
a working medium circuit in which a liquid working medium circulates, including an evaporator arranged in the region of the first pressure and a condenser arranged in the region of the second pressure;
a low pressure membrane arrangement permeable to a working medium vapour, impermeable to the liquid working medium and the liquid absorbent, and arranged between the evaporator and the absorber such that it is in contact with the working medium and the absorbent;
a high pressure membrane arrangement permeable to the working medium vapour, impermeable to the liquid working medium and the liquid absorbent, and arranged between the desorber and the condenser such that it is in contact with the working medium and the absorbent; and
wherein at least one of the low pressure membrane arrangement and the high pressure membrane arrangement include:
a working medium membrane in contact with the working medium, the working medium membrane being permeable to the working medium vapour, and impermeable to the liquid working medium;
an absorbent membrane in contact with the absorbent, the absorbent membrane being permeable to the working medium vapour and impermeable to the liquid absorbent; and
an interspace arranged between the working medium membrane and the absorbent membrane, the interspace evacuated to a reduced pressure that lies below the ambient pressure.
